(19) United States
(12) Patent Application Publication
(10) Pub. No.: US 2013/0340330 A1
(43) Pub. Date: Dec. 26, 2013

(54) Collapsible Shade for Lawn Cultivation

(71) Applicant: Robert Thomas DeSalle, JR., Wallingford, CT (US)

(72) Inventor: Robert Thomas DeSalle, JR., Wallingford, CT (US)

(21) Appl. No.: 13/922,476

(22) Filed: Jun. 20, 2013

Related U.S. Application Data
(60) Provisional application No. 61/662,780, filed on Jun. 21, 2012.
(60) Provisional application No. 61/669,917, filed on Jul. 10, 2012.

(51) Int. Cl. A01G 13/00

(52) U.S. Cl. CPC A01G 13/0206
USPC 47/29.6

(57) ABSTRACT

A collapsible shade for lawn cultivation is mesh fabric sheet that is supported above an area of grass or other vegetation by a plurality of stakes. The mesh fabric sheet is made of a meshed, knitted or woven material that reduces penetration across the mesh fabric sheet by sunlight and moisture, providing a moist, cool environment for the vegetation below. A flexible frame is held within a perimeter frame sleeve around the mesh fabric sheet, providing a folding capability for storage. A fabric side skirt may be attached connected around the mesh fabric sheet and affixed to the plurality of stakes to prevent small animals from damaging the vegetation in the protected area.

The current application claims a priority to the U.S. Provisional Patent application Ser. No. 61/662,780 filed on Jun. 21, 2012 and to the U.S. Provisional Patent application Ser. No. 61/669,917 filed on Jul. 10, 2012.

### FIELD OF THE INVENTION

The present invention relates generally to plant cultivation. More particularly, the present invention relates to an apparatus that provides shade and moisture entrapment over an area of outdoor vegetation in order to promote vegetation health.

### BACKGROUND OF THE INVENTION

The “American Dream” is the national ethos, or collection of guiding beliefs and ideals that characterize a community, nation, or ideology, of the United States. It describes a set of ideals in which freedom includes the opportunity for prosperity, success and upward social mobility through hard work. Home ownership is often equated with a quintessential fulfillment of the American dream and many people take great pride in cultivating an aesthetically appealing appearance and environment not only to enjoy being the occupants of but also to show off to their neighbors as a point of pride and status. The grass, vegetation or lawn surrounding a house is a significant portion of the visual aesthetic of the house, and having a healthy-looking lawn may make the difference between a source of pride for a homeowner and an embarrassment. Unfortunately, the time of year when people wish to care for and show off their lawns the most, summer, is also the toughest time of the year to do so. Direct, intense sun exposure, extreme temperatures (high or low) and other damaging conditions including heavy rain can make it nearly impossible to successfully germinate and grow grass seed in order to repair dead or damaged grass spots, and the amount of effort required to successfully do so is very high due to the frequent watering and other maintenance required to assure good seed germination and survival. In some areas such as the East Coast, this problem arises primarily during the summer months but in other, hotter parts of the country, this problem could potentially present itself for much longer, for example as early as April and as late as October. A controlled environment that is cool, shaded and moist is necessary to assure conditions for proper grass growth.

Many other outdoor areas employ large areas of grass, such as public parks, shopping centers and malls, athletic fields, golf courses and the like. Such areas require significant upkeep and maintenance, especially golf courses which are generally patronized by wealthier individuals and expect a high level of aesthetic appeal, neatness and orderliness. These grassy areas require considerable effort and expense to properly maintain against general wear and tear from sources such as harsh environmental conditions, animal waste, insect damage, foot traffic and other sources of damage. Damage is generally not inflicted consistently over the entirety of a grassy area, resulting in spots or patches of lawn damage, and the inconsistency of the appearance often contributes to the negative visual aesthetic of less-than-healthy grass.

It is therefore an object of the present invention to provide a portable apparatus that protects an area of grass or other vegetation from harsh environmental conditions such as sunlight, heavy rain, foot traffic and other damage, providing a cool, shaded, moist environment for the underlying grass to germinate and mature.

### BRIEF DESCRIPTION OF THE DRAWINGS

FIG. 1 is a perspective view of the full assembly of the present invention with dashed lines showing the hidden flexible frame within the perimeter frame sleeve.

FIG. 2 is a front cross sectional view of the full assembly of the present invention.

FIG. 3 is a top view of the present invention.

FIG. 4 is a perspective view of one of the plurality of stakes.

FIG. 5 is a perspective view showing the fabric side skirt being connected to the plurality of stakes.

### DETAIL DESCRIPTIONS OF THE INVENTION

All illustrations of the drawings are for the purpose of describing selected versions of the present invention and are not intended to limit the scope of the present invention.

The present invention is a portable apparatus that covers an area of ground with a shading material in order to provide a protective environment to grass or other vegetation. In particular, the present invention is intended to protect an area of grass from exposure to sunlight in addition to trapping moisture close to the ground, providing a cool, shaded, moist environment suitable for fostering healthy germination and growth of grass or other vegetation. The present invention is intended to facilitate cultivation of grass, seeds, fruits, low lying shrubs and trees, vegetables, crops, plants and lawns or any other vegetation that may benefit from a shaded, moist environment. The present invention also has the benefit of reducing water volume or frequency of watering required for adequate vegetation care.

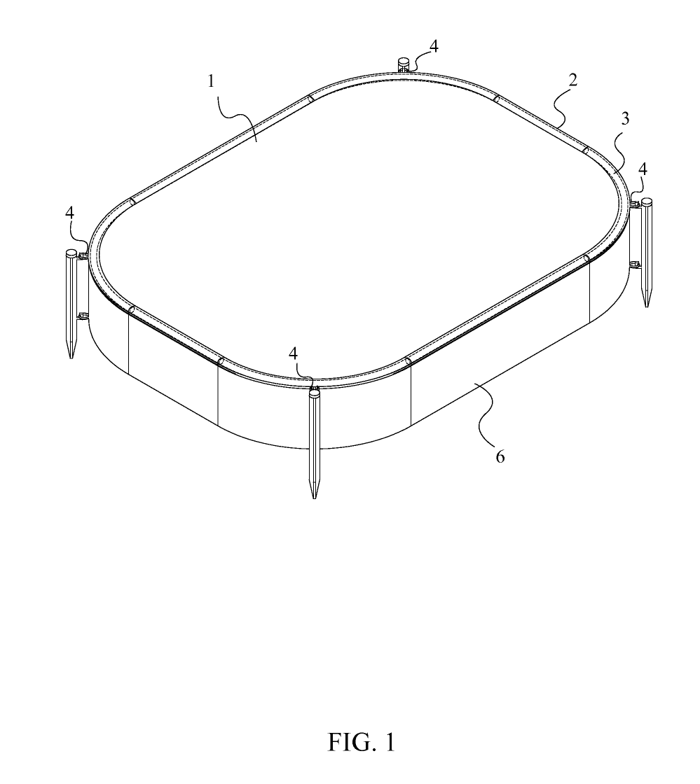

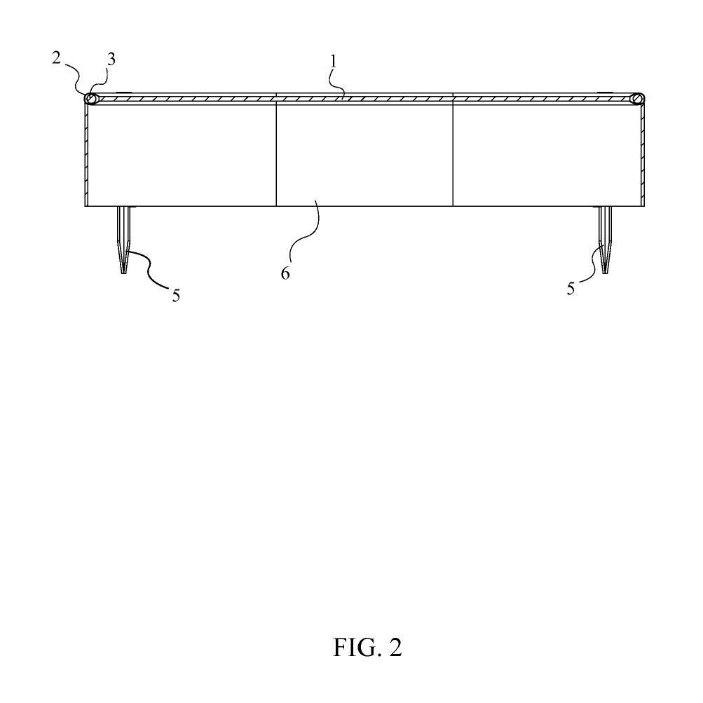

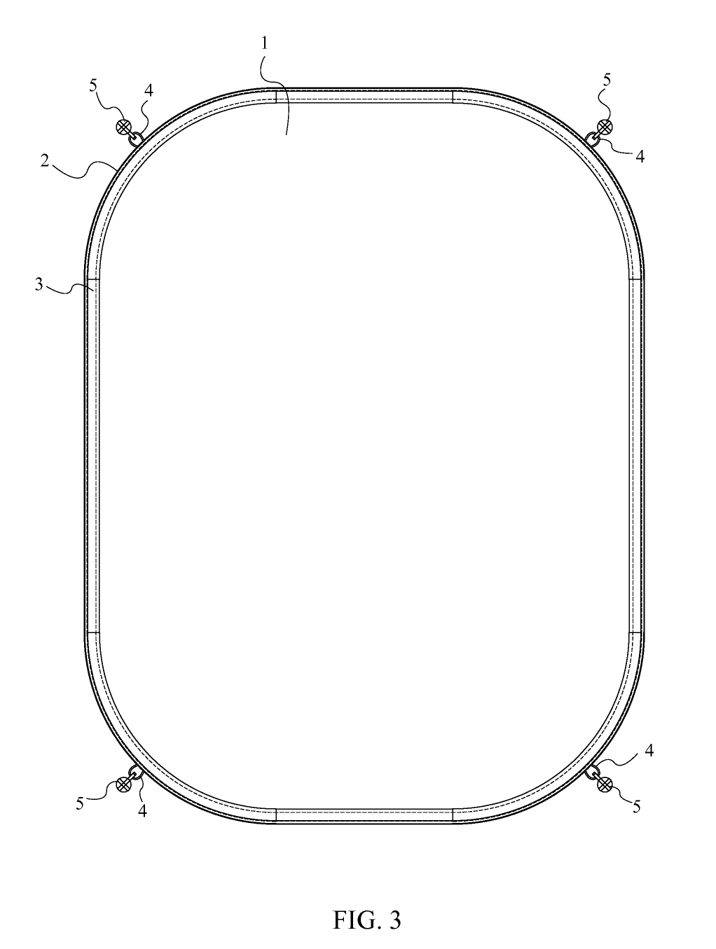

Referring to FIGS. 1-3, the present invention generally comprises a mesh fabric sheet 1, a perimeter frame sleeve 2, a flexible frame 3, a first plurality of stake connection loops 4, a plurality of stakes 5, and a fabric side skirt 6.

The mesh fabric sheet 1 is the primary component of the present invention and is the substantial majority of the physical structure of the present invention. The mesh fabric sheet 1 is preferably a woven material that reduces penetration of sunlight and moisture such as, but not limited to, agricultural mesh, printable fabric mesh, biodegradable hemp, corn plastic, high-density polyethylene, linear low-density polyethylene, low-density polyethylene, polypropylene, or other plastics or polymers. The mesh fabric sheet 1 is durable and able to withstand relatively strong forces, such as falling blunt objects and stresses due to wind. In alternate embodiments of the present invention, the mesh fabric sheet 1 is any other material or fabric that similarly accomplishes the goal of providing a shaded, moist environment to a portion of grass or other vegetation by reducing penetration of sunlight and moisture. The mesh fabric sheet 1 may be embodied in any number of geometrical configurations, such as, but not limited to, circular, rectangular, triangular, polygonal, and may be of any desired thickness. In the preferred embodiment of the present invention, the mesh fabric sheet 1 is flat while in use, being oriented substantially parallel to the ground and supported a short distance above the ground by the plurality of stakes 5. In the preferred embodiment of the present invention, the mesh fabric sheet 1 is rectangular with rounded corners. To illustrate by way of example, in one particular embodiment of the present invention, the mesh fabric sheet 1 is a rectangle that measures 3 feet by 4 feet with rounded corners that have a radius of 6 to 12 inches, but the mesh fabric sheet 1 is not limited to these dimensions. In a secondary preferred embodiment of the present invention, the mesh fabric sheet 1 is circular.

The mesh fabric sheet 1 protects grass or other vegetation beneath it from damaging sunlight and maintains a cool, moist environment beneath the mesh fabric sheet 1 that is more suitable for the underlying grass or vegetation to germinate and flourish. The mesh fabric sheet 1 prevents most air, heat and moisture from escaping or entering the protected area, but it does allow a certain amount of air, heat and moisture through. In one embodiment of the present invention, the mesh fabric sheet 1 reduces sunlight exposure by approximately 70 percent. In other embodiments, the mesh fabric sheet 1 reduces sunlight exposure by anywhere between 10 percent and 90 percent as appropriate for varying applications or environments. In alternate embodiments of the present invention, the mesh fabric sheet 1 reduces sunlight exposure by various other amounts appropriate for different applications. The mesh fabric sheet 1 may be of varying grades of mesh or materials which are more appropriate for varying purposes, such as, but not limited to, controlling the degree of exposure for sun, heat, cold, rain, sleet, hail or other potentially damaging conditions.

As can be seen in FIGS. 1-3, the perimeter frame sleeve 2, the flexible frame 3 and the mesh fabric sheet 1 are concentrically positioned with each other, wherein the perimeter frame sleeve 2 and the flexible frame 3 outline the mesh fabric sheet 1. The perimeter frame sleeve 2 is a loop or tube of fabric that is perimetrically attached around the mesh fabric sheet 1, creating a roughly circular or teardrop shaped track or tunnel. In the preferred embodiment of the present invention, the flexible frame 3 is a continuous flexible rod and is permanently integrated into the present invention within the perimeter frame sleeve 2 from the factory. In an alternate embodiment, the flexible frame 3 may be disconnected or removed from the mesh fabric sheet 1 for storage. The flexible frame 3 outlines the mesh fabric sheet 1, being positioned within the perimeter frame sleeve 2, and gives the present invention a supporting structure so that the present invention may be properly deployed. The flexible frame 3 is strong but flexible, such that without constraining forces the flexible frame 3 is fully expanded into the correct perimeter shape. However, the present invention may be collapsed for storage. To do so, a user grips the flexible frame 3 through the perimeter frame sleeve 2 and folds the present invention onto itself in a twisting manner common to foldable photography reflectors. The end result is that the flexible frame 3 is essentially doubled or tripled onto itself, significantly reducing the physical space occupied by the present invention, which may then be placed into a zippered bag or other storage means that maintains the present invention in the folded configuration.

In the preferred embodiment of the present invention, each of the first plurality of stake connection loops 4 is a strip of fabric that is attached to the perimeter frame sleeve 2. The first plurality of stake connection loops 4 is positioned around the perimeter frame sleeve 2 opposite the mesh fabric sheet 1, and the first plurality of stake connection loops 4 are equally spaced apart from each other around the perimeter frame sleeve 2. The first plurality of stake connection loops 4 is the means in the preferred embodiment of connecting the mesh fabric sheet 1 to the plurality of stakes 5 in order to hold the mesh fabric sheet 1 elevated a certain distance over the ground. In one embodiment, each of the first plurality of stake connection loops 4 is a strip of fabric or other flexible material that is attached to the perimeter frame sleeve 2 at both ends of the strip of fabric, creating a closed loop that can be removably connected to one of the plurality of stakes 5. In another embodiment, each of the first plurality of stake connection loops 4 is attached to the perimeter frame sleeve 2 at only one end, allowing a user to manually tie the first plurality of stake connection loops 4 to the plurality of stakes 5. Alternate embodiments of the present invention may comprise alternate means for attaching the perimeter frame sleeve 2 to the plurality of stakes 5 to hold the mesh fabric sheet 1 elevated over the ground, such as, but not limited to, clips, snaps, permanently attached stakes, or other appropriate or useful means.

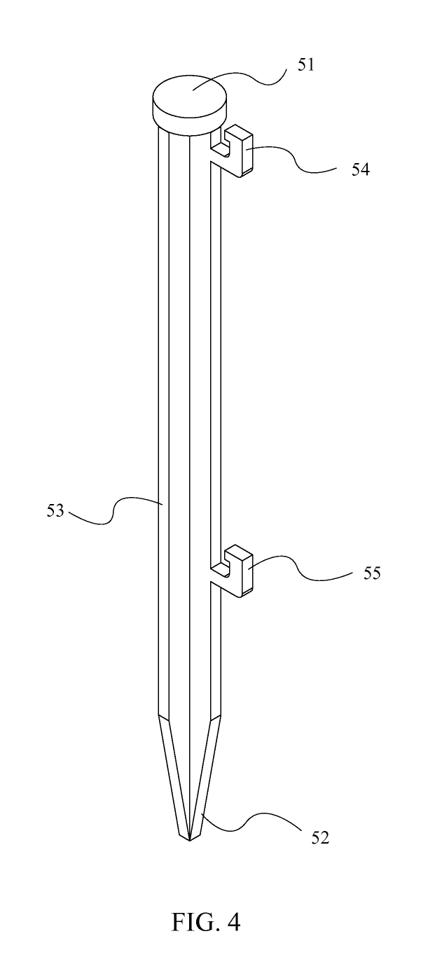

Referring to FIG. 4, in the preferred embodiment of the present invention, each of the plurality of stakes 5 comprises an upper extremity 51, a lower extremity 52, a middle portion 53, a first loop attachment location 54 and a second loop attachment location 55. The upper extremity 51 and the lower extremity 52 are positioned opposite each other along the plurality of stakes 5. The middle portion 53 is positioned between the upper extremity 51 and the lower extremity 52. The first loop attachment location 54 is positioned adjacent to the upper extremity 51, and the second loop attachment location 55 is positioned on the middle portion 53.

In the preferred embodiment of the present invention, each of the first loop attachment location 54 and the second loop attachment location 55 is an aperture traversing through each of the plurality of stakes 5. In another embodiment, each of the first loop attachment location 54 and the second loop attachment location 55 is a notch, protrusion or clip, or other appropriate means to properly interface with the perimeter frame sleeve 2 in order to hold the mesh fabric sheet 1 elevated above the ground. To deploy the present invention, the first plurality of stake connection loops 4 is affixed to the plurality of stakes 5 at the first loop attachment location 54 so that the plurality of stakes 5 supports the perimeter frame sleeve 2, and therefore the mesh fabric sheet 1, above the ground. The stake is driven into the ground far enough that the lower extremity 52 is below the ground surface, and the second loop attachment location 55 is approximately at or just below the ground surface, wherein the middle portion 53 traverses into or is adjacent to ground level.

The fabric side skirt 6 is preferably an elongated portion of fabric or other material that may be connected around the mesh fabric sheet 1 in order to block animals from entering under the mesh fabric sheet 1 when in use and trampling, eating, or otherwise damaging the vegetation being cultivated. The fabric side skirt is a removable, optional accessory for the present invention and is not critical to the primary function of the present invention, which is to reduce penetration of sunlight and entrap moist air. When the fabric side skirt 6 is in use, the fabric side skirt 6 is concentrically positioned around the mesh fabric sheet 1 adjacent to the perimeter frame sleeve 2. The fabric side skirt 6 is removably connected to the perimeter frame sleeve 2, and is removably connected to the plurality of stakes 5.

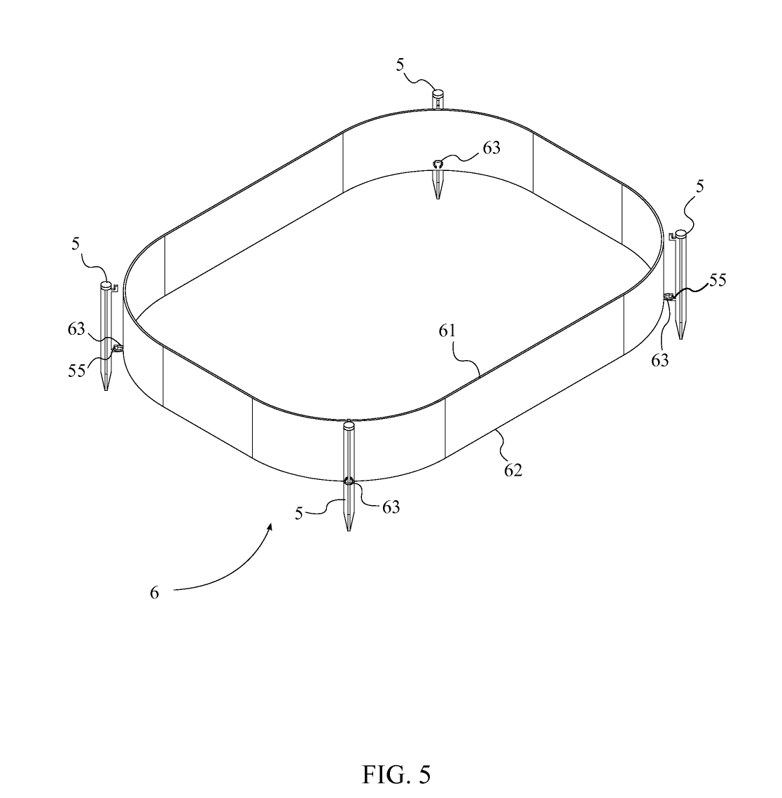

Referring to FIG. 5, the fabric side skirt 6 comprises a perimeter connection edge 61, a stake connection edge 62, and a second plurality of stake connection loops 63. In the preferred embodiment of the present invention, the perimeter connection edge 61 is connected to the perimeter frame sleeve 2 by strips of hook and loop tape. In alternate embodiments of the present invention, the perimeter connection edge 61 is connected to the perimeter frame sleeve 2 by a plurality of snaps, clips or other attachment means.

The perimeter connection edge 61 is positioned opposite the stake connection edge 62, wherein the perimeter connection edge 61 is positioned adjacent to the perimeter frame sleeve 2 and the stake connection edge 62 is positioned adjacent to the ground when the fabric side skirt 6 is in use. The second plurality of stake connection loops 63 is similar to the first plurality of stake connection loops 4, and is similarly removably connected to the second loop attachment location 55 of the plurality of stakes 5, so that when the fabric side skirt 6 is in use small animals are blocked from crawling under the mesh fabric sheet 1.

One embodiment of the present invention further comprises a plurality of interconnecting clips which is positioned on the perimeter frame sleeve 2 and equally spaced apart around the perimeter frame sleeve 2. The plurality of interconnecting clips allows multiple instances of the present invention to be connected with each other, allowing a user to protect and cultivate vegetation in a larger area than the area covered by just one instance of the present invention, or to provide coverage around obstacles in the user's yard, for example. The plurality of interconnecting clips uses any available well-known, common or new clip design to facilitate multiple instances of the present invention to be interconnected with each other. The plurality of interconnecting clips is spaced apart around the perimeter frame sleeve 2 in appropriate positions relative to the overall shape of the mesh fabric sleeve in order to facilitate creating a grid by connecting multiple instances of the present invention that effectively covers the maximum area possible.

The preferred embodiment of the present invention additionally incorporates a strip of reflective material affixed to the perimeter frame sleeve 2 to create a reflective border. The reflective border may be affixed on one or both sides of the mesh fabric sheet 1 and, in the case of having the reflective border on both sides, the reflective border may be comprised of one strip of material per side, one strip of material that is applied to both sides of the shade by wrapping around the edge from one side to the other, or any other configuration of pluralities of pieces, shapes or arrangements of reflective material.

Although the invention has been explained in relation to its preferred embodiment, it is to be understood that many other possible modifications and variations can be made without departing from the spirit and scope of the invention as hereinafter claimed.

What is claimed is:

1. A collapsible shade for lawn cultivation comprises:
a mesh fabric sheet;
a perimeter frame sleeve;
a flexible frame;
a plurality of stake connection loops;
a plurality of stakes;
a fabric side skirt;
each of the plurality of stakes comprises an upper extremity, a lower extremity, a middle portion, a first loop attachment location and a second loop attachment location; and
the mesh fabric sheet being concentrically positioned with the perimeter frame sleeve and the flexible frame.

2. The collapsible shade for lawn cultivation as claimed in claim 1 comprises:
the perimeter frame sleeve being perimetrically attached around the mesh fabric sheet; and
the flexible frame being positioned within the perimeter frame sleeve, wherein the flexible frame is a continuous flexible rod.

3. The collapsible shade for lawn cultivation as claimed in claim 1 comprises:
the plurality of stake connection loops being positioned around the perimeter frame sleeve opposite the mesh fabric sheet; and
the plurality of stake connection loops being equally spaced apart from each other around the perimeter frame sleeve.

4. The collapsible shade for lawn cultivation as claimed in claim 1, wherein the plurality of stake connection loops is removably connected to the plurality of stakes at the first loop attachment location.

5. The collapsible shade for lawn cultivation as claimed in claim 1 further comprises:
the upper extremity and the lower extremity being positioned opposite each other along the plurality of stakes;
the middle portion being positioned between the upper extremity and the lower extremity;
the first loop attachment location being positioned adjacent to the upper extremity; and
the second loop attachment location being positioned on the middle portion.

6. The collapsible shade for lawn cultivation as claimed in claim 1 further comprises:
the fabric side skirt being concentrically positioned with the mesh fabric sheet;
the fabric side skirt being removably connected to the perimeter frame sleeve;
the fabric side skirt being removably connected to the plurality of stakes; and
the fabric side skirt comprises a perimeter connection edge, a stake connection edge, and a plurality of stake connection loops.

7. The collapsible shade for lawn cultivation as claimed in claim 6 further comprises:
the perimeter connection edge being positioned opposite the stake connection edge;
the plurality of stake connection loops being attached to the stake connection edge; and
the plurality of stake connection loops being removably connected to the second loop attachment location of the plurality of stakes.

8. The collapsible shade for lawn cultivation as claimed in claim 1, wherein the mesh fabric sheet is agricultural mesh.

9. The collapsible shade for lawn cultivation as claimed in claim 1, wherein the mesh fabric sheet is any material that reduces penetration by sunlight and moisture.
